(19) United States
(12) Patent Application Publication
(10) Pub. No.: US 2025/0300997 A1
(43) Pub. Date: Sep. 25, 2025

(54) INFORMATION PROCESSING APPARATUS AND CONTROL METHOD FOR THE SAME

(71) Applicant: CANON KABUSHIKI KAISHA, Tokyo (JP)

(72) Inventors: NOBUHIRO TAGASHIRA, Chiba (JP); YUKI MINETOMO, Kanagawa (JP); TAKAMI EGUCHI, Tokyo (JP)

(21) Appl. No.: 19/078,000

(22) Filed: Mar. 12, 2025

(30) Foreign Application Priority Data
Mar. 22, 2024 (JP) 2024-046763

(51) Int. Cl. H04L 9/40

(52) U.S. Cl. CPC H04L 63/1416; H04L 63/1441

(57) ABSTRACT

Disclosed is an information processing apparatus that includes a first detection unit configured to definitively detect an abnormal behavior of the information processing apparatus, a second detection unit configured to stochastically detect the abnormal behavior of the information processing apparatus, and a countermeasure determination unit configured to determine a countermeasure against the abnormal behavior of the information processing apparatus based on results of detections by the first detection unit and the second detection unit.

### BACKGROUND

### Field

The present disclosure relates to an information processing apparatus and a control method for appropriate detections and countermeasures taken against cyberattacks.

### Description of the Related Art

There have been various services provided through the Internet. Some are related to social infrastructures, others handle financial and personal information. While the Internet serves as the foundation of information society, cyberattacks targeting these services occur frequently, which poses a major threat. For this reason, countermeasures taken against cyberattacks are considered important.

As countermeasures against recent advanced cyberattacks, attention is given to a defensive technology for preventing hacking into devices, as well as a countermeasure technology for minimizing damage in such cases. The latter one corresponds to an intrusion detection technology or an Endpoint Detection and Response (EDR) solution.

Methods for detecting cyberattacks using EDR come in two methods: a rule-based detection and a statistical detection.

The rule-based detection, also known as a signature detection, is a method with which abnormal patterns are registered in advance in a database (DB), and an anomaly is detected based on whether a target event corresponds to one of the registered patterns.

The statistical detection, also known as an anomaly detection, is a method with which normal patterns are registered in advance in a DB and an anomaly is detected based on whether a target event does not correspond to any of the registered patterns.

The technique discussed in Japanese Patent No. 6964829 involves units for detecting fraudulent communications through the rule-based detection and the statistical detection, and determines a detection unit to which a piece of communication data is to be distributed based on load statuses of the two detection units. This makes it possible to dynamically switch between the two units depending on the load statuses, and to detect fraudulent communications using the units without duplicating a detection system.

Japanese Patent No. 6964829 discusses the two detection methods for detecting cyberattacks.

However, the detection methods alone are described. Specific countermeasures against cyberattacks are to be considered separately, which does not lead to an effective solution.

### SUMMARY

The present disclosure is directed to providing appropriate countermeasures determined after detections are made based on detection results with a plurality of detection methods, as well as from which detection method.

According to an aspect of the present disclosure, an information processing apparatus includes a first detection unit configured to detect an abnormal behavior of the information processing apparatus, a second detection unit configured to stochastically detect the abnormal behavior of the information processing apparatus, and a countermeasure determination unit configured to determine a countermeasure against the abnormal behavior of the information processing apparatus based on results of detections by the first detection unit and the second detection unit.

Further features of the present disclosure will become apparent from the following description of exemplary embodiments with reference to the attached drawings.

### BRIEF DESCRIPTION OF THE DRAWINGS

FIG. 1 is a block diagram illustrating a multi-function peripheral (MFP), an office environment, and a connection to an Internet environment according to an exemplary embodiment of the present disclosure.

FIGS. 2A and 2B are diagrams illustrating an internal configuration of the MFP according to the disclosure.

FIG. 3 is a block diagram illustrating the configuration of software executed in a controller of the MFP according to the present disclosure.

FIG. 4 is a diagram illustrating a screen configuration related to a menu according to the present disclosure.

FIG. 5 is a diagram illustrating a screen configuration related to settings according to the present disclosure.

FIG. 6 is a diagram illustrating a screen configuration related to administrator authentication according to the present disclosure.

FIG. 7 is a diagram illustrating a screen configuration related to security settings according to the present disclosure.

FIG. 8 is a flowchart for performing a process of according to the present exemplary disclosure.

FIG. 9 is another block diagram illustrating the MFP, an office environment, and a connection form in an Internet environment according to the present disclosure.

FIG. 10 is a block diagram illustrating the configuration of software executed in the controller of the MFP and the configuration of software executed in a cloud service according to the present disclosure.

FIG. 11 is a block diagram illustrating an MFP, an office environment, and a connection form in an Internet environment according to the present disclosure.

### DESCRIPTION OF THE EMBODIMENTS

An exemplary embodiment of the present disclosure will be described.

Exemplary embodiments will be described with reference to the drawings. In the exemplary embodiments, an information processing apparatus detects cyberattacks through the Internet to take appropriate countermeasures. The exemplary embodiments will be described taking an MFP as an example, but the present disclosure is a technique applicable to desirable information processing apparatus other than the MFP.

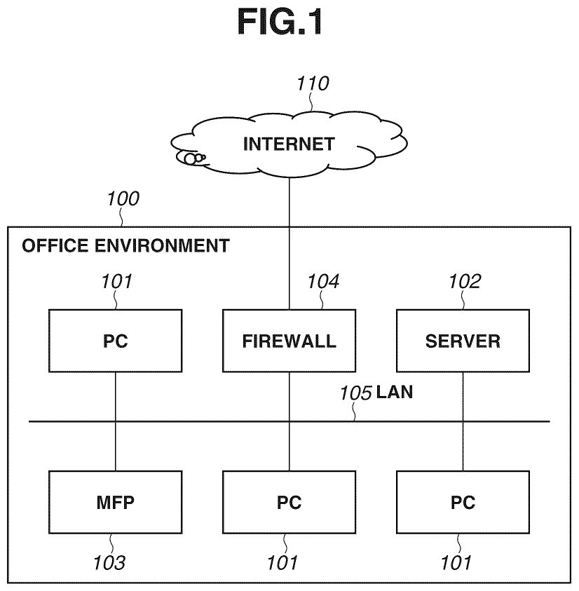

FIG. 1 is a system configuration diagram illustrating a connection form between an office environment 100 and the Internet 110 according to an exemplary embodiment of the present disclosure. A local area network (LAN) 105 is installed in the office environment 100 where personal computers (PCs) 101, a server 102, an MFP 103, and a firewall 104 are connected via the LAN 105. The PCs 101 perform office work processing and transmit print jobs to the MFP 103. The server 102 controls office work and provides data storage services. The MFP 103 has a function of outputting electronic data on paper media and reading the paper media to convert the read data into electronic data.

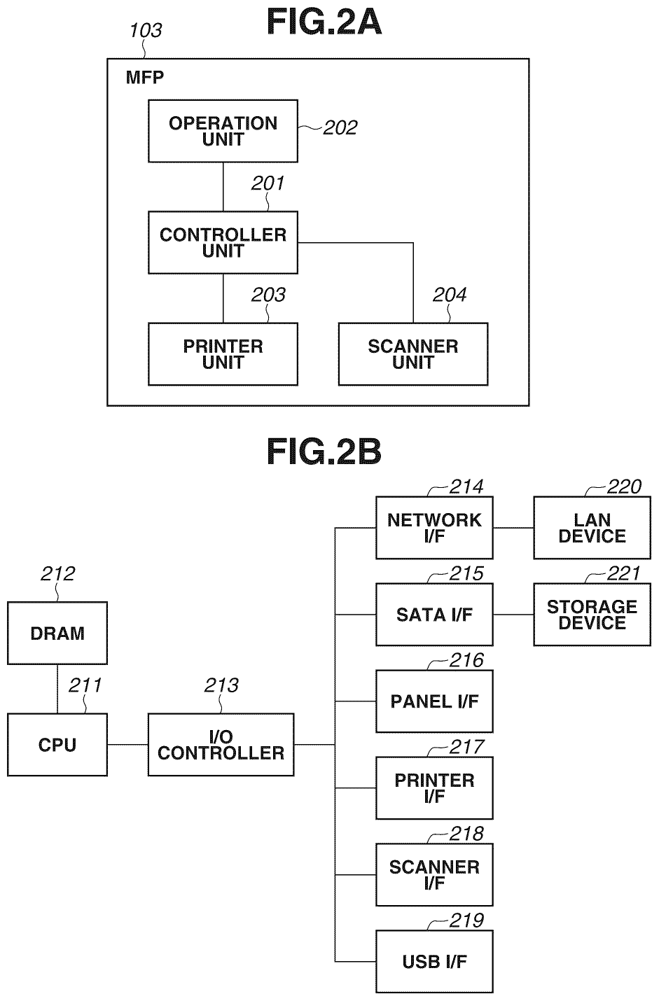

The LAN 105 is connected to the Internet 110 via the firewall 104. The PCs 101, the server 102, and the MFP 103 access the Internet 110 via the firewall 104. FIGS. 2A and 2B illustrate a configuration of the MFP 103.

As illustrated in FIG. 2A, the MFP 103 includes an operation unit 202 for a user to transmit and receive data. The MFP 103 includes a printer unit 203 that outputs electronic data on paper media. The MFP 103 includes a scanner unit 204 that reads paper media to convert the read data into electronic data. The operation unit 202, the printer unit 203, and the scanner unit 204 are connected to a controller unit 201, and function as an MFP under the control of the controller unit 201.

FIG. 2B is a block diagram illustrating a physical configuration of the controller unit 201 of the MFP 103.

A central processing unit (CPU) 211 performs main arithmetic processing in the controller unit 201. The CPU 211 is connected to the dynamic random access memory (DRAM) 212 via a bus. The DRAM 212 is used by the CPU 211 as a working memory for temporarily storing program data indicating arithmetic instructions during the arithmetic process and data to be processed. The CPU 211 is connected to an input/output (I/O) controller 213 via a bus. The I/O controller 213 performs input/output to and from various devices in response to instructions from the CPU 211.

A network interface (I/F) 214 is connected to the I/O controller 213, and a LAN device 220 is connected to the network I/F 214. The CPU 211 controls the LAN device 220 via the network I/F 214 to perform communications on the LAN 105. This enables communications via the Internet 110.

A Serial Advanced Technology Attachment (SATA) I/F 215 is connected to the I/O controller 213, and a storage device 221 is connected to the SATA I/F 215. The storage device 221 may be one or more of a hard disk drive (HDD), a solid state drive (SSD), or a flash memory. The CPU 211 uses the storage device 221 to permanently store programs for carrying out functions of the MFP 103, various types of setting data, and document files.

A panel I/F 216 is connected to the I/O controller 213, and the CPU 211 enables the user to transmit/receive information using the operation unit 202 via the panel I/F 216. A printer I/F 217 is connected to the I/O controller 213, and the CPU 211 enables output of paper media using the printer unit 203 via the printer I/F 217. A scanner I/F 218 is connected to the I/O controller 213, and the CPU 211 enables reading of original documents using the scanner unit 204 via the scanner I/F 218. A universal serial bus (USB) I/F 219 is connected to the I/O controller 213 to control devices connected to the USB I/F 219.

When performing a copy function, the CPU 211 reads program data from the storage device 221 into the DRAM 212 via the SATA I/F 215. The CPU 211 detects a copy instruction issued by the user through the operation unit 202 via the panel I/F 216 based on the programs read into the DRAM 212. Upon detection of the copy instruction, the CPU 211 receives original data as electronic data via the scanner I/F 218 from the scanner unit 204 and stores the electronic data in the DRAM 212. The CPU 211 performs color conversion processing suitable for the output on the image data stored in the DRAM 212. The CPU 211 transfers the image data stored in the DRAM 212 via the printer I/F 217 to the printer unit 203, and causes the printer unit 203 to perform output processing on a paper medium.

In page description language (PDL) printing, one of the PCs 101 issues a print instruction via the LAN 105. The CPU 211 reads program data from the storage device 221 via the SATA I/F 215 into the DRAM 212, and detects the print instruction via the network I/F 214 based on the programs read into the DRAM 212. Upon detection of a PDL transmission instruction, the CPU 211 receives print data via the network I/F 214, and stores the print data in the storage device 221 via the SATA I/F 215. At the completion of saving the print data, the CPU 211 loads the print data saved in the storage device 221 into the DRAM 212 as image data. The CPU 211 performs color conversion processing suitable for the output on the image data stored in the DRAM 212. The CPU 211 transfers the image data stored in the DRAM 212 via the printer I/F 217 to the printer unit 203, and causes the printer unit 203 to perform output processing on a paper medium.

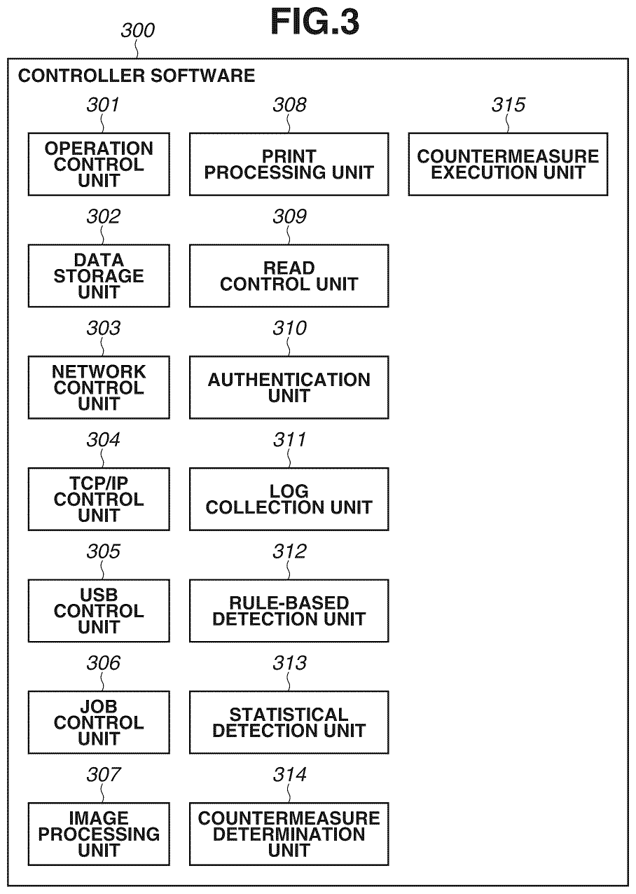

FIG. 3 is a block diagram illustrating the configuration of software executed by the controller unit 201 of the MFP 103. The description of system software, such as Basic Input/Output System (BIOS) and operating system (OS), is understood by those of skill in the art and is not repeated here. The CPU 211 executes the software in the controller unit 201. The CPU 211 reads controller software 300 stored in the storage device 221 into the DRAM 212 to execute the controller software 300.

An operation control unit 301 displays a screen image for the user on the operation unit 202, detects user operations, and performs processing associated with screen components, such as buttons displayed on the screen.

In response to a request from another control unit, a data storage unit 302 stores and reads data in and from the storage device 221. For example, when the user changes one or more apparatus settings, the operation control unit 301 detects the details of inputs to the operation unit 202 by the user, and in response to a request from the operation control unit 301, the data storage unit 302 saves the details in the storage device 221 as setting values.

A network control unit 303 makes network settings, such as Internet Protocol (IP) address settings, to a Transmission Control Protocol (TCP)/IP control unit 304 at the start of the system or when a change in settings is detected, based on the setting values stored in the data storage unit 302.

The TCP/IP control unit 304 performs transmission and reception of network packets via the network I/F 214 in response to instructions from other control units.

A USB control unit 305 controls the USB I/F 219 to control desired USB-connected devices.

A job control unit 306 controls job execution in response to instructions from other control units.

An image processing unit 307 processes image data into a format suitable for each application in response to instructions from the job control unit 306.

A print processing unit 308 prints to output images on paper media via the printer I/F 217 in response to instructions from the job control unit 306.

A read control unit 309 reads original documents via the scanner I/F 218 in response to instructions from the job control unit 306. For example, when the copy function is performed, the operation control unit 301 detects a request for carrying out the copy function and instructs the job control unit 306 to make a copy. The job control unit 306 instructs the read control unit 309 to read an original document to acquire a scanned image. The job control unit 306 instructs the image processing unit 307 to convert the scanned image into a format suitable for printing. The job control unit 306 instructs the print processing unit 308 to print and output the copy result.

An authentication unit 310 determines whether the operator is an administrator authorized to perform operations with administrator authority. In secure printing in which printing is started after the authentication of a user of the MFP to prevent the printed product(s) from being improperly removed, the authentication unit 310 determines whether the operator is a user of the MFP.

A log collection unit 311 collects various behaviors of the MFP 103 as log data in order to detect cyberattacks, and records the log data in the storage device 221. Representative examples of the log data include an event log, a system log, a network log, and a security log, examples of which are described herein.

The event log includes data on MFP events described in the following.

Specifically, the event log may include “starts/stops of the MFP and the times”, “user/administrator login/logout times”, “starts/stops of programs and services, and the times”, “user operations, such as printing, scanning, and copying (operation details and operation times)”. The event log may also include “operations (operation details and operation times) of system setting values, such as passwords and other account information, times, access control lists, networks, and certificates”.

The system log includes data on the MFP system described in the following.

Specifically, the system log may include “kernel messages and debug information”, “disk and file system errors and warnings”, “hardware events, such as temperature and power supply statuses”, and “CPU usage, memory usage, and storage usage”, “network traffics and bandwidths” and “application response times”.

The network log includes data on the MFP network described in the following.

Specifically, the network log may include “transmission/reception destination addresses (IP addresses)”, “transmission/reception times”, “transmission/reception intervals”, “transmission/reception data sizes”, and “transmission/reception data payloads”.

The security log may include data on the security of the MFP. Specifically, the security log may include “failed login attempts”, “account locks/unlocks”, and “permitted/denied access controls to administrator functions, files, and directories (boxes)”.

The security may log also include “firewall controls and denials”.

These log data can be collected using a system log service (e.g., syslog), or an audit daemon (e.g., Auditd).

A rule-based detection unit 312 registers abnormal behaviors in a DB in advance, and detects an anomaly based on whether the behavior of a detection target corresponds to one of the registered behaviors. Thus, the rule-based detection unit 312 includes a management unit that manages abnormal behaviors, and a comparison unit that compares a behavior of the detection target with those managed by the management unit. Since the rule-based detection is made through a comparison with abnormal behaviors, that can definitively detect an anomaly in some cases. The behaviors here are registered as information obtained by analyzing the logs collected with the log collection unit 311.

Examples of detection using logs classified as event logs include the start of a program for debugging, which is not executed in use cases of an MFP normally operating. Such a program startup is registered in the management unit as an abnormal behavior, and the program startup is compared by the comparison unit. If a start of a program registered as a program that is not to be executed during normal operations is detected, the startup is an abnormal behavior.

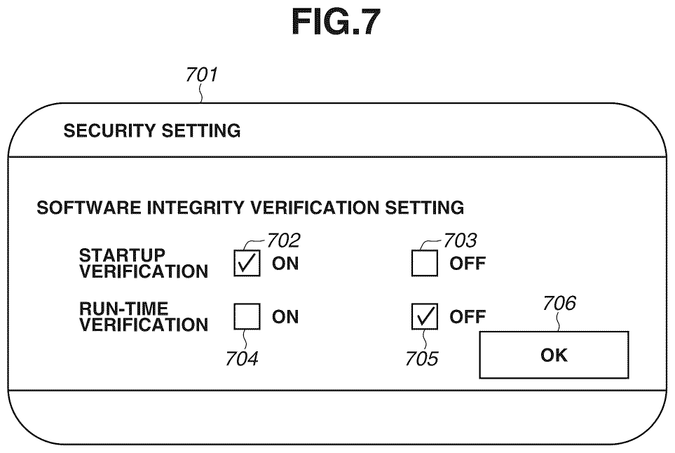

Another example of detection using logs classified as event logs is a change of the system settings performed by someone other than the administrator. Such behavior is registered in the management unit as an abnormal behavior, and the change of the system settings is compared by the comparison unit. If the system settings are changed with the administrator not being logged in, the behavior is detected as an abnormal behavior. The system settings include a startup verification and a run-time verification, which will be described below with reference to FIG. 7, but are not limited to such specific system settings.

Another example of detection using logs classified as event logs is a change in the system settings that are variable in a general-purpose system but are fixed and unchangeable in use cases of the MFP. Such behavior is registered in the management unit as an abnormal behavior, and the change in the system settings is compared by the comparison unit. If such a system setting is changed, the behavior is detected as an abnormal behavior. The system settings that are fixed and unchangeable for cases using MFPs include environment variables and login scripts, but are not limited to such specific settings.

Examples of detection using logs classified as network logs include the IP addresses of command and control servers (C&C servers), which are control sources of malware and transmission destinations of data in events of information leakage. Data transmission and reception to and from such IP addresses are registered in the management unit as abnormal behaviors, and the data transmission and reception are compared by the comparison unit. If the data transmission and reception to and from the IP addresses registered as an unauthorized data recipient are detected, the behaviors are detected as abnormal behaviors.

Another example of detection using logs classified as network logs is transmission of data outside of the usage hours of an MFP. Certain usage hours of MFPs are linked to the installation locations. For an MFP installed in a library, usage hours are the library opening hours. Similarly, for an MFP installed in a retail store, usage hours are the retail store's business hours. In addition, for an MFP installed in an office, the MFP administrator may explicitly set its usage hours. Such data transmission outside of usage hours is registered in the management unit as an abnormal behavior, and the data transmission is compared by the comparison unit. If data is transmitted outside of the registered usage hours, the behavior is detected as an abnormal behavior.

While examples of the rule-based detection have been described above, the above examples do not include all the rule-based detection examples, and rule-based detection examples are not limited to the above examples.

The statistical detection unit 313 registers normal behaviors in the DB in advance, and detects an anomaly based on whether the behavior of a detection target does not correspond to any of the registered behaviors. Thus, the statistical detection unit 313 includes a management unit that manages normal behaviors, and a determination unit that calculates the similarities between the behavior of a detection target and the behaviors managed by the management unit to determine whether each similarity exceeds a threshold. Unlike the rule-based detection, the statistical detection is a stochastic detection since the detection is performed based on similarity. The behaviors here are registered as information obtained by analyzing logs collected with the log collection unit 311, as with the rule-based detection unit 312.

An example of detection using logs classified as event logs is times of user operations, such as printing, scanning, and copying. The operation hours of a user A who works during regular business hours are registered in the management unit as regular business hours. If the user A performs an operation during a time different from the times registered in the management unit, that operation is detected as a stochastically abnormal behavior.

Another example of detection using logs classified as event logs is printing of a large amount of data during a time different from the normal usage time. The user A's regular operation hours are registered in the management unit, and the operation hours are determined by the determination unit. If the user A performs a large amount of printing during a time different from the time registered in the management unit, that operation is detected as a stochastically abnormal behavior.

An example of detection using logs classified as network logs is data transmission to the C&C servers, which are control sources of malware and transmission destinations of data in events of information leakage. The example of using an IP address is given in the above description of the rule-based detection. However, IP addresses are frequently changed in some cases. Thus, while IP addresses cannot be identified, a program for unclear purpose is detected as a stochastically abnormal behavior from among programs continuously sending data at specific times or at fixed intervals.

In the above description, the stochastic detection is performed with the management unit and the determination unit, but the stochastic detection can also be performed using machine learning. Normal behaviors are input into a machine learning system as learning data to generate a learning model of the normal behaviors. This model can be used to detect behaviors of a detection target. The above-described detection methods are some of the combinations of logs, e.g., “time”, “time and number of pages printed”, and “data transmission interval”. However, using machine learning, various combinations of logs can be used and may be form black box data.

While examples of the statistical detection have been described above, the above examples are not all the statistical detection examples, and statical detection examples are not limited to such examples.

A countermeasure determination unit 314 determines a countermeasure based on the results of detections by the rule-based detection unit 312 or the statistical detection unit 313, i.e., based on what results of detections by the detection unit 313. The rule-based detection unit 312 is capable of a definitive detection, while the statistical detection unit 313 is capable of a stochastic detection. The definitive detection makes it possible to determine and take a countermeasure. On the other hand, with the stochastic detection, there remains a possibility of erroneous detection, and a countermeasure can be determined. However, such countermeasure is difficult to determine regarding the actually execution of the countermeasure. Thus, for an abnormal behavior determined as a result of a definitive detection made by the rule-based detection unit 312, the countermeasure determination unit 314 determines that “a countermeasure is to be determined and executed”. In other cases, the countermeasure determination unit 314 determines that “a countermeasure is to be determined and the abnormal behavior and the determined countermeasure are to be notified to the administrator”.

One specific countermeasure is to restart the MFP. Recent MFPs have a startup tampering detection function and an automatic recovery function. Thus, MFPs detect tampering with system software, such as BIOS and an OS, and the controller software 300 at the start of an MFP. Upon detection of tampering, the MFP recovers the original software via retrieval from a securely protected area or a network. Enabling these functions and restarting the MFP is one of the effective countermeasures. Another countermeasure is function reduction, which includes the shutdown of a network or the disablement of the functions related to an abnormal behavior. Abnormal behaviors vary, and a plurality of countermeasures can be executed for one abnormal behavior. Since it is difficult to specify the countermeasure(s) for each abnormal behavior, the countermeasures against an abnormal behavior are not limited here.

A countermeasure execution unit 315 executes a countermeasure determined by the countermeasure determination unit 314.

When the countermeasure determination unit 314 determines that “a countermeasure is to be determined and executed”, the countermeasure execution unit 315 executes the determined countermeasure. An example of countermeasures is to restart the MFP. The settings of the startup tampering detection function and the automatic recovery function are checked. If the settings are disabled, the settings are changed to be enabled, and the MFP is restarted. The timing of executing a countermeasure may be immediately after the detection of an abnormal behavior and the determination of the countermeasure. Otherwise, the timing of executing a countermeasure may be determined considering the operating state of the MFP, such as during printing or scanning.

When the countermeasure determination unit 314 determines that “a countermeasure is to be determined and the abnormal behavior and the determined countermeasure are to be notified to the administrator”, the countermeasure execution unit 315 issues a warning to the administrator. The warning to the administrator can be issued on the operation unit 202, or can be sent to a pre-registered e-mail address as warning information.

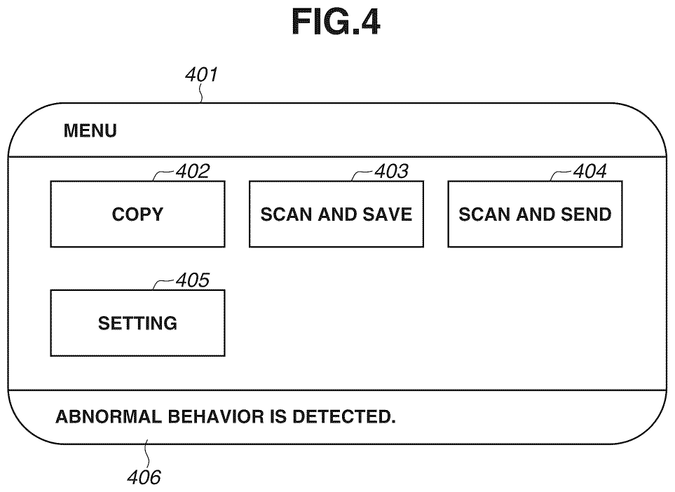

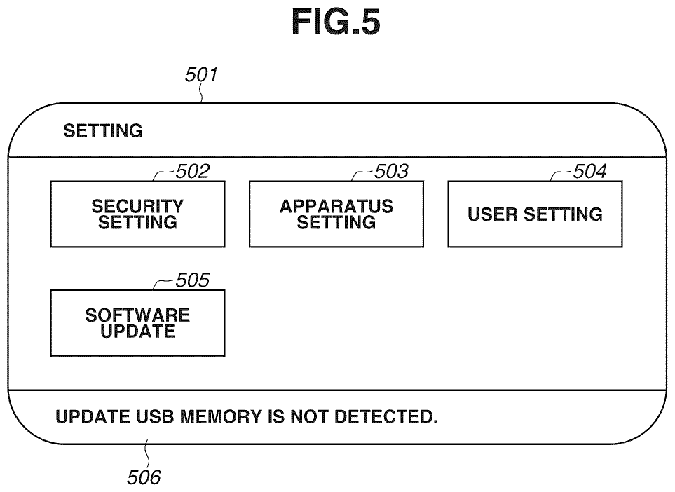

FIG. 4 illustrates a menu screen 401 displayed on the operation unit 202, which allows the user to issue instructions for the execution of various functions of the MFP 103. A button 402 is used by the user to issue an instruction for execution of the copy function. A button 403 is used by the user to issue an instruction for execution of the scan and save function. A button 404 is used by the user to issue an instruction for execution of the scan and send function. A button 405 is used by the user to issue an instruction for making changes to the settings of the apparatus. Pressing the button 405 causes a setting screen 501 (FIG. 5) to be displayed. In a display area 406, various messages for the user about events that occur during operation of the apparatus are displayed. For example, a warning from the countermeasure execution unit 315 can be displayed in the display area 406.

FIG. 5 illustrates the setting screen 501 displayed on the operation unit 202, which allows the user to specify various settings. This screen itself does not have specific setting items, but is an intermediate hierarchy that serves as a guide to detailed setting items. Pressing a button 502 allows the user to move to a security setting screen 701 (FIG. 7). Pressing a button 503 causes an apparatus setting screen to be displayed. Pressing a button 504 causes a user setting screen to be displayed. Pressing a button 505 causes a software update to be started. In a display area 506, various messages for the user about events that occur during operation of the apparatus are displayed.

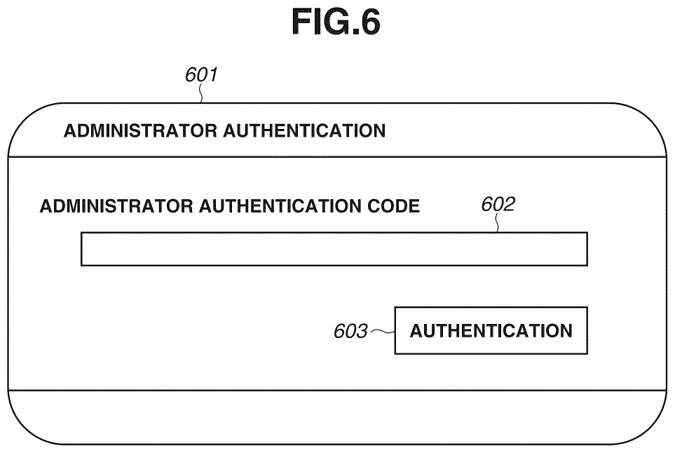

FIG. 6 illustrates an administrator authentication screen 601 displayed on the operation unit 202, which is used by the user to enter an administrator authentication code. This screen is displayed prior to the execution of a function with the administrator authority, and is used to check whether the user is an operator with the administrator authority. For example, the administrator authentication screen 601 is displayed before the security setting screen 701 is displayed or before the button 505 is pressed to start a software update. An area 602 is an area in which the user enters the administrator authentication code, and a button 603 is used to start to check the authentication code entered in the area 602. The authentication code is checked by the authentication unit 310. If the authentication is successful, the process with the administrator authority is executed. If the authentication fails, the process with the administrator authority is not executed.

FIG. 7 illustrates a security setting screen 701, which is used to make security settings to the MFP 103. For example, when a startup verification 702 is selected, a startup verification function is enabled to verify the integrity of the controller software 300 at the start of the system. When a run-time verification 704 is selected, a run-time verification function is enabled to verify the integrity of the software to be executed at the execution of the software. Pressing button 706 initiates storing the selected state on the security setting screen 701 as apparatus settings in the data storage unit 302. Since the software verification processing of the startup verification function and run-time verification function require time for calculating the verifications, the operation speed of the apparatus is slow compared to when no verification is performed. Thus, there is a trade-off between safety and processing performance. The administrator makes the settings in consideration of operation, installation policy, and user satisfaction. While the MFP 103 is a multi-user device, that screen can be operated by an operator with the administrator authority alone. The users are affected by the settings, but the administrator alone makes the settings.

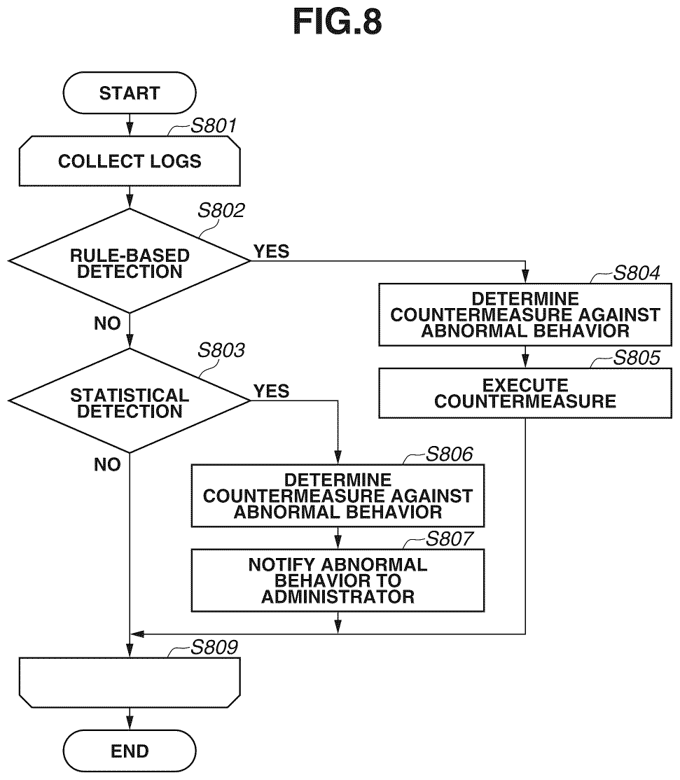

A procedure of processing in which the controller software 300 of the MFP 103 detects an abnormal behavior of the MFP 103 and executes a countermeasure in the MFP 103 will now be described with reference to FIG. 8.

In step S801, the log collection unit 311 collects logs of the MFP 103.

In step S802, the rule-based detection unit 312 uses the logs collected in step S801 to detect an abnormal behavior. If an abnormal behavior is detected (YES in step S802), the process proceeds to S804. If abnormal behavior is not detected (NO in step S802), the process proceeds to S803.

In step S803, the statistical detection unit 313 uses the logs collected in step S801 to detect an abnormal behavior. If an abnormal behavior is detected (YES in step S803), the process proceeds to S806. If abnormal behavior is not detected (NO in step S803), the log collection unit 311 continues log collection in step S809.

In step S804, the countermeasure determination unit 314 determines a countermeasure based on the information detected as the abnormal behavior through the detection unit and the detection result.

In step S805, the countermeasure execution unit 315 executes the countermeasure determined in step S804.

In step S806, the countermeasure determination unit 314 determines a countermeasure based on the information detected as an abnormal behavior through the detection unit, and the detection result.

In step S807, the countermeasure execution unit 315 provides notification to the administrator of the countermeasure determined in step S806 and warning information regarding the abnormal behavior.

The above-described processing enables the detection of an abnormal behavior of an information processing apparatus caused by cyberattacks and to execute an appropriate countermeasure against the detected abnormal behavior.

In the present exemplary embodiment, while the configuration has been described of carrying out all the functions by the MFP 103 alone, the case has been described in which the statistical detection unit 313 is implemented with machine learning. Since machine learning uses computational resources, it may be difficult to implement machine learning in the MFP 103 alone. To address this issue, the statistical detection unit 313 may be offloaded to a cloud service.

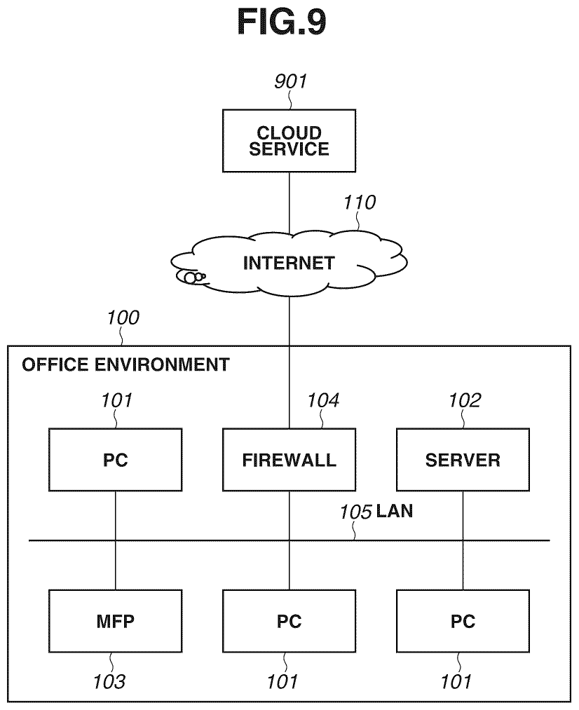

FIG. 9 is a diagram illustrating a system configuration in which the statical detection unit 313 is offloaded to a cloud service. The MFP 103 can access a cloud service 901 via the LAN 105, the firewall 104, and the Internet 110 in an office environment, as described above.

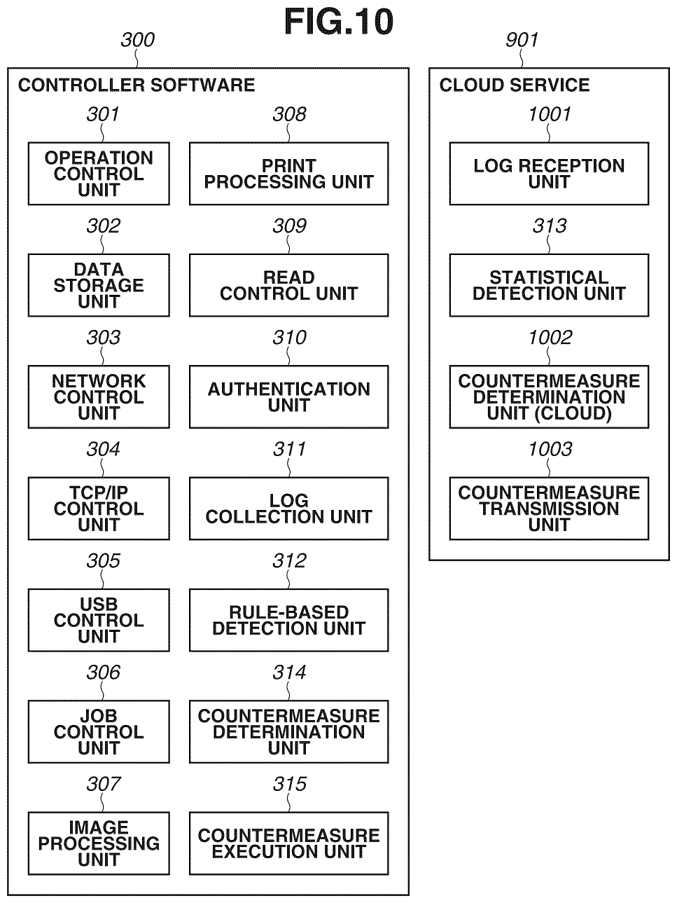

FIG. 10 illustrates a software configuration in which the statical detection unit 313 is offloaded to a cloud service.

In addition to the exemplary embodiment described above with reference to FIG. 3, the software configuration of FIG. 10 includes a log reception unit 1001 and a countermeasure determination unit (cloud) 1002. As illustrated in FIG. 10, the log reception unit 1001, the statistical detection unit 313, the countermeasure determination unit (cloud) 1002, and a countermeasure transmission unit 1003 are provided on the cloud service. The statistical detection unit 313 and the countermeasure determination unit (cloud) 1002 are similar to those described above with reference to FIG. 3. The log reception unit 1001 receives from the MFP 101 log information used in processing by the statistical detection unit 313 on the cloud service, and the countermeasure transmission unit 1003 transmits the countermeasure determined by the statistical detection unit 313 on the cloud service to the MFP 103.

These configurations allow offloading of the statistical detection unit 313 to the cloud service, making it possible to perform statistical detections using machine learning that uses computational resources.

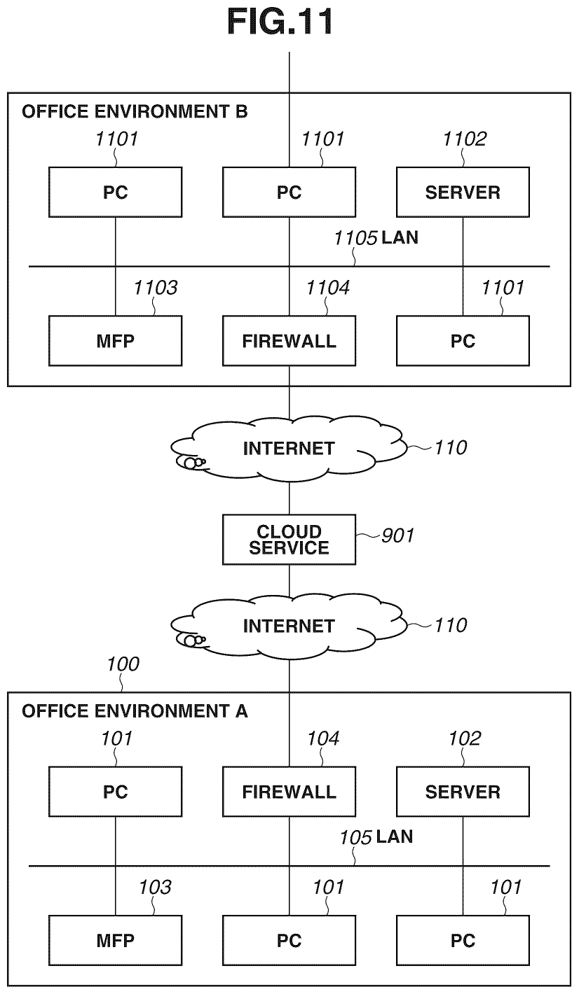

Offloading of the statistical detection unit 313 to the cloud service also makes it possible to perform statistical detections using log information from a single MFP 103, as well as log information from another MFP 1103, as illustrated in FIG. 11, which illustrates interconnection between office environment A and office environment B. The PCs 1101, server 1102, MFP 1103, and firewall 1104 of FIG. 11 are similar to the PCs 101, server 102, MFP 103, and firewall 104 of FIG. 9, description of which is incorporated by reference for conciseness.

Embodiment(s) of the present disclosure can also be realized by a computer of a system or apparatus that reads out and executes computer executable instructions (e.g., one or more programs) recorded on a storage medium (which may also be referred to as a non-transitory computer-readable storage medium) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., CPU, micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-046763, filed Mar. 22, 2024, the entirety of which is incorporated herein by reference.

What is claimed is:

1. An information processing apparatus comprising:
a first detection unit configured to detect an abnormal behavior of the information processing apparatus;
a second detection unit configured to stochastically detect the abnormal behavior of the information processing apparatus; and
a countermeasure determination unit configured to determine a countermeasure against the abnormal behavior of the information processing apparatus based on results of detections by the first detection unit and the second detection unit.

2. The information processing apparatus according to claim 1,
wherein the first detection unit is further configured to detect the abnormal behavior of the information processing apparatus based on a startup of a program or a change in setting data.

3. The information processing apparatus according to claim 1,
wherein the first detection unit is further configured to detect the abnormal behavior of the information processing apparatus based on a rule, and
wherein the second detection unit is further configured to detect the abnormal behavior of the information processing apparatus based on stochastic processing.

4. The information processing apparatus according to claim 3, wherein in a case a program is not started in a normal operation, the first detection unit detects the startup as the abnormal behavior.

5. The information processing apparatus according to claim 1, wherein the countermeasure determination unit is further configured to determine the countermeasure against the result of the detection by the first detection unit, execute the countermeasure in the information processing apparatus, determine the countermeasure against the result of the detection by the second detection unit, and issue a warning.

6. The information processing apparatus according to claim 5, wherein, as the countermeasure against the result of the detection by the first detection unit, the countermeasure determination unit enables at least one of a tamper detection function and an automatic recovery function of at least one of system software and controller software in the information processing apparatus.

7. The information processing apparatus according to claim 6, wherein, in response to the countermeasure determination unit enabling at least one of the tamper detection function and the automatic recovery function, the information processing apparatus restarts.

8. The information processing apparatus according to claim 5, wherein as the countermeasure against the result of the detection by the first detection unit, the countermeasure determination unit shuts down a network that includes the information processing apparatus.

9. A control method for an information processing apparatus, the control method comprising:
detecting an abnormal behavior of the information processing apparatus;
stochastically detecting the abnormal behavior of the information processing apparatus; and
determining a countermeasure against the abnormal behavior of the information processing apparatus based on results of the detected abnormal behavior and the stochastically detected abnormal behavior.

10. A non-transitory storage medium storing a program causing an information processing apparatus to execute a control method, the control method comprising:
detecting an abnormal behavior of the information processing apparatus;
stochastically detecting the abnormal behavior of the information processing apparatus; and
determining a countermeasure against the abnormal behavior of the information processing apparatus based on results of the detected abnormal behavior and the stochastically detected abnormal behavior.
